(19) United States
(12) Patent Application Publication
(10) Pub. No.: US 2026/0205897 A1
(43) Pub. Date: Jul. 16, 2026

(54) METHODS, SYSTEMS, AND APPARATUSES FOR A SPLIT CELL ARCHITECTURE

(71) Applicant: Comcast Cable Communications, LLC, Philadelphia, PA (US)

(72) Inventors: William Zapar, Philadelphia, PA (US); Ahmed Galal, Philadelphia, PA (US)

(21) Appl. No.: 19/025,288

(22) Filed: Jan. 16, 2025

(51) Int. Cl. H04W 36/00; H04W 36/08; H04W 36/30

(52) U.S. Cl. CPC H04W 36/0064; H04W 36/0072; H04W 36/08; H04W 36/30

(57) ABSTRACT

Methods, systems, and apparatuses for performing device handovers in a small node system are described herein. An example method may include receiving, at a termination system from a base station centralized unit (CU), a prescheduling message indicating a handover of a device to a base station distributed unit (DU), and based on the prescheduling message, determining an allocation of resources to use to communicate to the device via the base station DU. The example method may further include based on receipt of the data intended for the device, sending the data using the allocation of resources to the base station DU.

### BACKGROUND

Existing cell node architectures include a centralized unit at the cell node to handle various functionality. However, inclusion of the centralized unit with the cell node generally leads to increased power consumption, as well as a need for larger or more conductors to handle the traffic. However, moving the centralized unit out of the node architecture may lead to other issues, such as increased latency. These and other considerations are discussed herein.

### SUMMARY

It is to be understood that both the following general description and the following detailed description are explanatory only and are not restrictive. In transmission of low latency data, waiting for handover between nodes and devices presents delays. For example, waiting during a handover process that includes scheduling resources may exceed the allotted latency (e.g., 10 ms or less). Thus, to mitigate this latency, a network node, such as a base station centralized unit (base station-CU), may communicate with a termination system to preschedule a resource allocation instruction for a transfer of a user device, or other equipment, to a different network node, such as a base station distributed unit (base station-DU), prior to the handover being completed. In one aspect, when the base station centralized unit has received an indication from the target base station distributed unit that the handover has started, the base station centralized unit may send a prescheduling message, e.g., with a timer, to the termination system to allow it to start scheduling resource allocation processes prior to receiving data or content intended for the user device or other equipment. The prescheduling command between the base station centralized unit and the termination system may reduce latency as compared with solutions that wait to schedule resources until a handover or transfer of the user device or other equipment to the target node has been initiated or completed.

Other examples are possible as well. Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 depicts a block diagram of a system in accordance with embodiments of the disclosure.

FIG. 2 is a sequence diagram of a handover process for in a RAN in accordance with embodiments of the disclosure.

FIG. 3 is a sequence diagram of an end-to-end QoS process for RAN in accordance with embodiments of the disclosure.

FIG. 4 is a block diagram depicting a system/environment in accordance with embodiments of the disclosure.

FIG. 5 depicts a flowchart of an example method to perform a handover operation in accordance with embodiments of the disclosure.

FIG. 6 depicts a flowchart of an example method to perform a handover operation in accordance with embodiments of the disclosure.

FIG. 7 depicts a flowchart of an example method to perform a QoS update operation in accordance with embodiments of the disclosure.

FIG. 8 depicts a flowchart of an example method to perform a handover operation in accordance with embodiments of the disclosure.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The method steps recited throughout this disclosure may be combined, omitted, rearranged, or otherwise reorganized with any of the figures presented herein and are not intended to be limited to the four corners of each sheet presented. The techniques disclosed herein may be implemented on a computing device(s) in a way that improves performance and/or efficiency of operation, as further described herein.

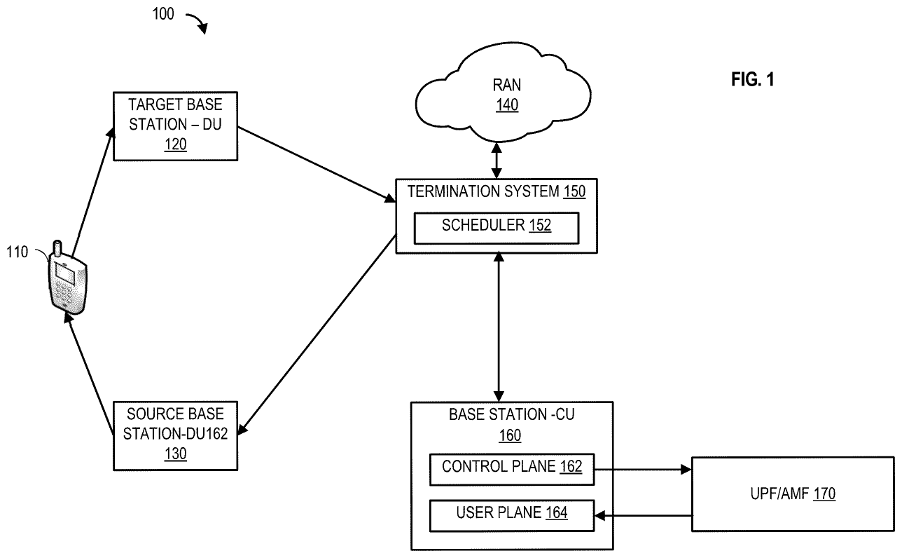

FIG. 1 depicts a block diagram of a system 100, in accordance with embodiments of the disclosure. The system 100 may include, for example, a user equipment (UE) 110, a target base station-DU 120, a source base station-DU 130, a radio access network (RAN) 140, a termination system 150, a base station-CU 160, and access management function (AMF)/user plane function (UPF) 170. The RAN 140 may include a centralized RAN (CRAN), a cloud-based RAN (C-RAN), a next generation RAN (NG-RAN), or similar that provides content to end user devices, such as the UE 110, via the RAN 140, the target base station-DU 120, and/or the source base station-DU 130. This content may comprise, for example, video, audio, text, web pages, images, files, data, services, applications, etc. The UE 110 may include any device used by an end user, such as a smart phone or other mobile device, laptop, tablet, router, Internet of Things (IoT) devices, or any other device equipped with a mobile broadband adapter.

The system 100 may include a hybrid of two different types of networks. For example, the RAN 140 and the termination system 150 may operate according to any known or desirable standard, such as the DOCSIS standard, published by Cable Television Laboratories, Inc., (e.g., low latency standards, such as the low latency DOCSIS standard). The UE 110, the target base station-DU 120, the source base station-DU 130, the base station-CU 160, and the AMF/UPF 170 may operate according to a 3^{rd} Generation Partnership Project (3GPP) interfaces standard (e.g., including long-term evolution (LTE) (and any derivative) interfaces, 5G new radio (and any derivative) interfaces), and non-3GPP interfaces (e.g., any derivative of Wi-Fi) interfaces. For example, the UE 110, the target base station-DU 120, the source base station-DU 130, the base station-CU 160, and the AMF/UPF 170 may operate according to a 5G network standard.

The system 100 may include a split baseband unit (BBU) or base station architecture, where base station (e.g., generation node B (gNB)) functionality is split between one or more centralized units (e.g., the base station-CU 160) and one or more distributed units (e.g., the target base station-DU 120 and/or the source base station-DU 130).

The target base station-DU 120 and the source base station-DU 130 may include a logical node that hosts (e.g., handles) one or more lower layers in the protocol stack, such as radio link control (RLC), medium access control (MAC), and physical (PHY) layers of the gNB.

The base station-CU 160 may include a logical node that hosts (e.g., handles) one or more upper layers in the protocol stack. For example, the base station-CU 160 may handle a radio resource control (RRC) layer, a physical data convergence protocol (PDCP) layer, and/or a service data application protocol (SDAP) layer of the gNB. The base station-CU 160 may include a control plane 162 and a user plane 164. The base station-CU 160 may communicate with the target base station-DU 120, the source base station-DU 130, the termination system 150, and/or the base station-CU 160 via the control plane 162 and/or the user plane 164. For example, the base station-CU 160 may have a one to many relationship with the target base station-DU 120 and source base station-DU 130, and may support additional base station-DUs.

For example, the base station-CU 160 may hosted at a location remote from the target base station-DU 120 and/or the source base station-DU 130, such as a centralized data center. For example, the base station-CU 160 may be co-located with the AMF/UPF 170. For example, the base station-CU 160 may be virtualized (e.g., hosted on a virtual machine or in one or more software containers running on a server or other computing device, including a cloud computing device). While the system 100 of FIG. 1 depicts a single one of the termination system 150 and two of the base station-DUs (e.g., the target base station-DU 120 and the source base station-DU 130), it is appreciated that the system 100 may include additional base station-CUs and/or additional base station-DUs without departing from the scope of the disclosure.

The termination system 150 may manage communications between devices (e.g., the UE 110 via the target base station-DU 120 and/or the source base station-DU 130) and the RAN 140. For example, the termination system 150 may include a cable modem termination system (CMTS). For example, the interface of the termination system 150 may be configured according to a standard, such as one or more of the known or desirable standards, such as wireless network standards, DOCSIS standards (e.g., including the low latency DOCSIS standard), etc. The termination system 150 may be configured to place content on one or more downstream channels or frequencies to be received by user equipment devices (e.g., the UE 110), and to receive upstream communications from those modems on one or more upstream frequencies. The 104 may also include one or more network interfaces (e.g., implemented using associated software and/or hardware), which can permit the termination system 150 to communicate with various other external networks (e.g., networks of Internet devices, telephone networks, cellular telephone networks, fiber optic networks, local wireless networks (e.g., WiMAX), satellite networks, and any other desired network. The termination system 150 may include a scheduler 152 to allocate resources for provision of content to the UE 110. For example, functionality of the base station-CU 160 may be separate from functionality of the termination system 150, as shown in FIG. 1. Separating these two functions may improve efficiency, as the base station-CU 160 may be more closely located with the AMF/UPF 170. However, moving the base station-CU 160 away from the termination system 150 may present an opportunity for additional messaging interfaces between the termination system 150 and the base station-CU 160 to accommodate new architecture. For example, as explained below, the termination system 150 and the base station-CU 160 may include a prescheduling message interface for scheduling resource allocation during a handover of the UE 110 from one of the target base station-DU 120 or the source base station-DU 130 to the other. The termination system 150 and the base station-CU 160 may also include a quality of service (QoS) prescheduling interface to schedule QoS for certain types of content.

The AMF/UPF 170 may include an UPF and an AMF. The AMF may comprise one or more of the following functionalities: RAN control plane interface, termination of access between the termination system 150 and the UE 110, ciphering and integrity protection, registration management, connection management, reachability management, mobility management, lawful intercept (for AMF events and interface to LI system), transport for session management, session management messages between the UE 110 and a session management function (not shown), transparent proxy for routing session management messages, access authentication, access authorization, transport for short message service (SMS) messages between wireless device UE 110 and an SMS function (SMSF), security anchor function (SEA) interaction with authentication server function and the UE 110, receiving an intermediate key established as a result of the UE 110 authentication process, security context management (SCM), and/or receiving a key from the security anchor function (SEA) to derive access network specific keys. A variety of these functionalities may be supported in a single instance of the AMF and/or in multiple instances of the AMF as appropriate.

For example, the AMF may support 3GPP interfaces, including LTE, 5G-NR, or any of their derivatives, or any combination thereof, and/or any non-3GPP interfaces (e.g., any derivative of Wi-Fi) interfaces.

The UPF of the AMF/UPF 170 may include one or more of the following functionalities: anchor point for Intra-/Inter-radio access technology (RAT) mobility, external packet data unit (PDU) session point of interconnect a data network (e.g., the RAN 140), packet routing and forwarding, packet inspection and user plane part of policy rule enforcement, lawful intercept (e.g., user plane (UP) (e.g., the user plane 164 of the base station-CU 160) collection), traffic usage reporting, uplink classifier to support routing traffic flows to a data network, branching point to support multi-homed PDU session(s), QoS handling for the user plane (e.g., the user plane 164 of the base station-CU 160), uplink traffic verification (service data flow (SDF) to QoS flow mapping), transport level packet marking in the uplink and downlink, downlink packet buffering, and/or downlink data notification triggering. One or more of these functionalities may be supported in a single instance of the UPF, or in multiple instances of the UPF.

In operation, the target base station-DU 120 or the source base station-DU 130, the termination system 150, and the base station-CU 160 may coordinate to provide content from the RAN 140 to the UE 110. For example, the UE 110 may include a mobile device that is capable of moving (e.g., being transported or carried) from one location to another. Thus, initially, the UE 110 may be connected to the system 100 via the source base station-DU 130. However, as the UE 110 is transported, it may move outside a coverage area of the source base station-DU 130 and into a coverage area of the target base station-DU 120. A determination as to whether communication with the UE 110 should be handled by the target base station-DU 120 or the source base station-DU 130 may be based on a measurement report sent by the UE 110 the one of the target base station-DU 120 or the source base station-DU 130 currently serving the UE 110. In the example depicted in FIG. 1, the UE 110 may be initially served by the source base station-DU 130. Accordingly, the UE 110 may send the measurement report to the source base station-DU 130. The measurement report may be sent periodically, for example. The measurement report may be sent in response to an event (e.g., power loss, request from the serving one of the target base station-DU 120 or the source base station-DU 130, etc.), for example. The measurement report may indicate signal quality for the serving one of the target base station-DU 120 or the source base station-DU 130, as well as signal quality for any neighboring ones of the target base station-DU 120 or the source base station-DU 130 ) or another base station-DU. The signal quality may include the reference signal received power (RSRP), reference signal received quality (RSRQ), signal-to-interference and noise ratio (SINR), or other quality metrics.

The measurement report may be sent to the base station-CU 160 in an uplink (UL) radio resource control (RRC) message. Based on the measurement report, the control plane 162 of the base station-CU 160 may determine whether the source base station-DU 130 should continue serving the UE 110, or whether the service should be transferred to the target base station-DU 120, in this example. That is, based on (e.g., in response to) one or more metrics in the measurement report corresponding to communication with the source base station-DU 130 satisfying a threshold (or one or more metrics in the measurement report corresponding to communication with the target base station-DU 120 not satisfying a threshold), the control plane 162 of the base station-CU 160 may hold service with the source base station-DU 130. In this example, everything remains status quo.

Based on one or more metrics in the measurement report corresponding to communication with the source base station-DU 130 not satisfying a threshold (or one or more metrics in the measurement report corresponding to communication with the target base station-DU 120 satisfying a threshold) the base station-CU 160 may initiate a transfer (e.g., handover or handoff) of service for the UE 110 to the target base station-DU 120. In this example, the base station-CU 160 and the target base station-DU 120 may communicate via a pair of request and response messages. For example, the base station-CU 160 may send a UE context setup request message to the target base station-DU 120, and the target base station-DU 120 may respond with a UE context setup response message acknowledging receipt. The UE context request message may initiate a setup to establish an initial UE context at the target base station-DU 120, including packet data unit (PDU) session context, a security key, a mobility restriction list, radio capabilities and security capabilities of the of the UE 110, etc.

The base station-CU 160 may notify the source base station-DU 130 that the UE 110 is being transferred to the target base station-DU 120. For example, the base station-CU 160 may notify the source base station-DU 130 that the UE 110 is being transferred to the target base station-DU 120 in response to (e.g., based on) completion of the handshake for the transfer between the base station-CU 160 and the target base station-DU 120. That is, the base station-CU 160 may send a UE context modification request message to the source base station-DU 130. The source base station-DU 130 may send a RRC reconfiguration message with a timer (e.g., a T304 timer) to the UE 110. For example, the source base station-DU 130 may send the RRC reconfiguration message with a timer (e.g., a T304 timer) to the UE 110 in response to the UE context modification request message. The timer may indicate to the UE 110 an amount of time the UE 110 must wait before completing the transfer. The source base station-DU 130 may send a UE context modification response message to the base station-CU 160. For example, the source base station-DU 130 may send the UE context modification response message to the base station-CU 160 after sending the RRC reconfiguration message1. The user plane 164 of the base station-CU 160 may start buffering user data for the UE 110. For example, the user plane 164 of the base station-CU 160 may start buffering user data for the UE 110 based on receipt of the UE context modification response message.

The UE 110 and the target base station-DU 120 may perform a random access procedure to set up communication between the UE 110 and the target base station-DU 120. The random access procedure may be contention based (e.g., the UE 110 independently selects from available preambles shared with all UEs) or contention free (e.g., the target base station-DU 120 allocates a dedicated preamble to the UE 110). During the random access procedure, the UE 110 sends a random access preamble to the target base station-DU 120. The target base station-DU 120 may respond with a random access response message. The UE 110 may be ready to communicate via the target base station-DU 120. Upon expiration of the timer, the UE 110 may send a RRC reconfiguration complete message to the target base station-DU 120, and in response, the target base station-DU 120 may sent a UL RRC reconfiguration message to the base station-CU 160 identifying the UE 110 as being served by the source base station-DU 130.

The UE 110 may be ready to begin receiving data from the base station-CU 160 and the termination system 150 via the target base station-DU 120. However, in the system 100, the termination system 150 is unaware that the handover procedure is taking place. That is, the termination system 150 had previously scheduled allocation of resources to communicate through the source base station-DU 130 to provide content to the UE 110. Once the UE 110 is transferred service to the source base station-DU 130, the termination system 150 may have to schedule allocation of different resources to communicate through the target base station-DU 120 to provide content to the UE 110.

In an example implementation involving low latency DOCSIS, waiting until the handover process is complete to start scheduling resources may exceed the allotted latency (e.g., 10 ms or less). Thus, to mitigate this additional latency, after the base station-CU 160 has received the UE context modification response from the target base station-DU 120, the base station-CU 160 may send a prescheduling message with the timer sent to the UE 110 by the target base station-DU 120 to indicate that the UE 110 is transferring service from the source base station-DU 130 to the target base station-DU 120. The scheduler 152 of the termination system 150 may start the process of setting up scheduling of resources to communication through the target base station-DU 120 to provide content to the UE 110. For example, the scheduler 152 of the termination system 150 may start the process of setting up scheduling of resources to communication through the target base station-DU 120 to provide content to the UE 110 based on (e.g., in response to) the prescheduling message. The base station-CU 160 may send the prescheduling request through a virtual 5G loopback interface of the termination system 150 including the timer time. If the termination system 150 starts receiving content before expiration of the timer time, the termination system 150 may communicate content through the target base station-DU 120 to the UE 110. If the termination system 150 does not start receiving content until after expiration of the timer time, the termination system 150 may revert to communicating content through the source base station-DU 130 to the UE 110 (e.g., indicative of the handover to the target base station-DU 120 failing). The prescheduling command between the base station-CU 160 and the termination system 150 may reduce latency as compared with solutions that wait to schedule resources until a handover or transfer of the UE 110 to the target base station-DU 120 is complete.

For example, the base station-CU 160 and the termination system 150 may include an interface to set up QoS for various content types. For example, the base station-CU 160 may perform SDAP Qos identification to determine QoS for various types of data and end user needs. The base station-CU 160 and the termination system 150 may exchange a pair of QoS setup request/response messages to set up end-to-end QoS. The setup may indicate a number of QoS tiers. For example, the termination system 150 and the base station-CU 160 may use a CMTS virtual 5G loopback interface to negotiate the QoS between the termination system 150 and the base station-CU 160 to establish an end-to-end QoS for the UE 110. When the termination system 150 receives a different QoS setup request, it may goes through a Kubernetes container that is part of a virtualized implementation of the termination system 150. The termination system 150 may align the required QoS from a 5G network to another network, such as a DOCSIS network, to provide complete end-to-end QoS. The termination system 150 may sequentially send the QoS tiers to be set up using DOCSIS unsolicited grant service (UGS) flows, with one QoS flow per DOCSIS UGS flow through a 5G cell to the target base station-DU 120 or the source base station-DU 130 (e.g., whichever is serving the UE 110).

Communication with the UE 110 may need to be transferred from the source base station-DU 130 to the target base station-DU 120 via a handover or handoff procedure. In some implementations, such as low latency DOCSIS implementations, the amount of permitted delay from the time the handover is completed until data starts being received at the user device may be small. Thus, an interface between the termination system 150 and the base station-CU 160 may be implemented to reduce latency during handover operation. In addition, the interface between the termination system 150 and the base station-CU 160 may preschedule QoS of data sent to the UE 110.

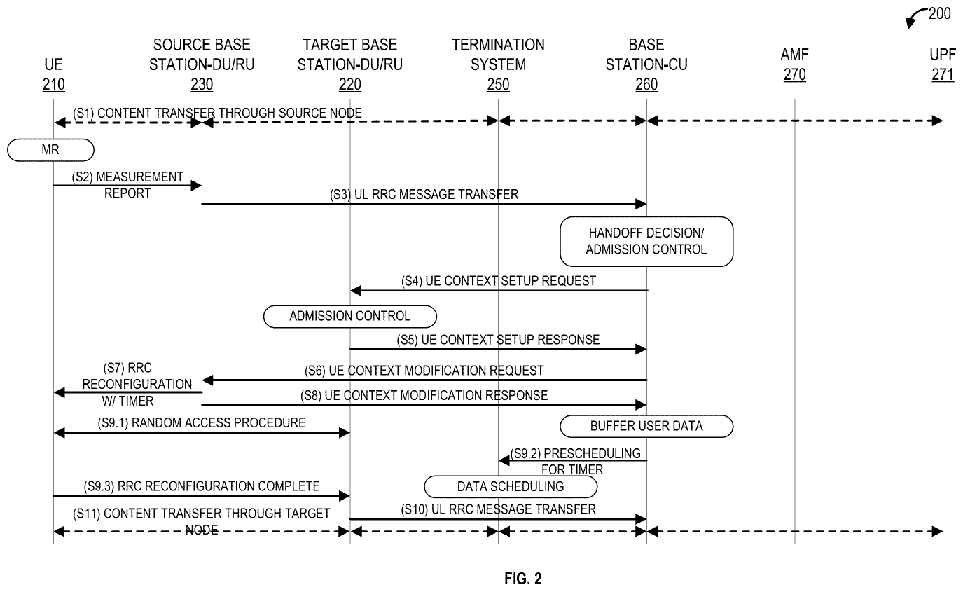

FIG. 2 is a sequence diagram 200 of a handover process for a RAN in accordance with embodiments of the disclosure. The user equipment 210, the target base station-DU 220, the source base station-DU 230, the termination system 250, the base station-CU 260, and the AMF 270/UPF 271 may correspond to the UE 110, the target base station-DU 120, the source base station-DU 130, the termination system 150, the base station-CU 160, and the AMF/UPF 170, respectively, of FIG. 1, for example.

As shown in FIG. 2, (S1) data and other messages may be transferred to the user equipment 210 via the source base station-DU 230. For example, the user equipment 210 may be a mobile device that moves from one location to another. As the user equipment 210 moves from one location to another, it may move outside a coverage area of the source base station-DU 230. To determine whether communication with the user equipment 210 should be handled by the target base station-DU 220 or the source base station-DU 230, the user equipment 210 may generate a measurement report, and may (S2) send a measurement report message to the source base station-DU 230. The (S2) measurement report message may be sent periodically, for example. The (S2) measurement report message may be sent in response to an event (e.g., power loss, request from the serving one of the target base station-DU 220 or the source base station-DU 130, etc.), for example. The data in the (S2) measurement report message may indicate signal quality for the serving one of the target base station-DU 220 or the source base station-DU 230, as well as signal quality for any neighboring ones of the target base station-DU 220 or the source base station-DU 230) or another base station - DU. The signal quality may include the reference signal received power (RSRP), reference signal received quality (RSRQ), signal-to-interference and noise ratio (SINR), or other quality metrics.

The source base station-DU 230 may send data from the measurement report to the base station-CU 260 in (S3) an uplink (UL) radio resource control (RRC) message. Based on the measurement report, base station-CU 260 may make a handoff and admission control decisions to determine whether the source base station-DU 230 should continue serving the user equipment 210, or whether the service should be transferred to the target base station-DU 220, in this example. Based on (e.g., in response to) one or more metrics in the measurement report corresponding to communication with the source base station-DU 230 satisfying a threshold (or one or more metrics in the measurement report corresponding to communication with the target base station-DU 220 not satisfying a threshold), the base station-CU 260 may hold service with the source base station-DU 230.

Based on one or more metrics in the measurement report corresponding to communication with the source base station-DU 230 not satisfying a threshold (or one or more metrics in the measurement report corresponding to communication with the target base station-DU 220 satisfying a threshold) the base station-CU 260 may initiate a transfer (e.g., handover or handoff) of service for the user equipment 210 to the target base station-DU 220.

In this example, the base station-CU 260 and the target base station-DU 220 may communicate via a pair of request and response messages. For example, the base station-CU 260 may send (S4) a UE context setup request message to the target base station-DU 220. The target base station-DU 220 may respond with (S5) a UE context setup response message acknowledging receipt. The (S4) UE context request message may initiate a setup to establish an initial UE context at the target base station-DU 220, including packet data unit (PDU) session context, a security key, a mobility restriction list, radio capabilities and security capabilities of the of the user equipment 210, etc.

The base station-CU 260 may notify the source base station-DU 130 that the UE 110 is being transferred to the target base station-DU 220. For example, in response to (e.g., based on) completion of the handshake for the transfer between the base station-CU 260 and the target base station-DU 220, the base station-CU 260 may notify the source base station-DU 130 that the UE 110 is being transferred to the target base station-DU 220. For example, the base station-CU 260 may send (S6) a UE context modification request message to the source base station-DU 230. The source base station-DU 230 may send (S7) a RRC reconfiguration message with a timer (e.g., a T304 timer) to the user equipment 210. For example, the source base station-DU 230 may send the (S7) RRC reconfiguration message with the timer (e.g., the T304 timer) to the user equipment 210 in response to the (S6) UE context modification request message. The timer may indicate to the user equipment 210 an amount of time the user equipment 210 must wait before completing the transfer. The source base station-DU 230 may send (S8) a UE context modification response message to the base station-CU 260. For example, the source base station-DU 230 may send the (S8) UE context modification response message to the base station-CU 260 after sending the (S7) RRC reconfiguration message. The base station-CU 260 may start buffering user data for the user equipment 210.

The user equipment 210 and the target base station-DU 220 may perform (S9.1) a random access procedure to set up communication between the UE 110 and the target base station-DU 120. The (S9.1) random access procedure may be contention-based (e.g., the user equipment 210 independently selects from available preambles shared with all UEs) or contention free (e.g., the target base station-DU 220 allocates a dedicated preamble to the user equipment 210). During the (S9.1) random access procedure, the user equipment 210 may send a random access preamble to the target base station-DU 220. The target base station-DU 220 may respond with a random access response message. The user equipment 210 may be ready to communicate via the target base station-DU 220. The user equipment 210 may send (S9.3) a RRC reconfiguration complete message to the target base station-DU 220. For example, the (S9.3) RRC reconfiguration complete message may be sent to the target base station-DU 220 in response to (e.g., based on) expiration of) the timer. The target base station-DU 220 may send (S10) a UL RRC message transfer to the base station-CU 260 identifying the user equipment 210 as being served by the source base station-DU 230. The he target base station-DU 220 may send the (S10) UL RRC message transfer to the base station-CU 160 identifying the user equipment 210 as being served by the source base station-DU 230 in response to receipt of the (S9.3) RRC reconfiguration complete message.

The base station-CU 260 may send (S9.2) a prescheduling message with the timer to the user equipment 210 by the target base station-DU 220 to indicate that the user equipment 210 is transferring service from the source base station-DU 230 to the target base station-DU 220. For example, the (S9.2) prescheduling message with the timer may be sent after the base station-CU 260 has received the (S8) UE context modification response to the target base station-DU 220. The (S9.2) prescheduling request message may be sent through a virtual 5G loopback interface of the termination system 250 including the timer time. The (S9.2) prescheduling message may be sent contemporaneous with the (S9.1) random access procedure. The termination system 250 may start the process of setting up scheduling of resources to communication through the target base station-DU 220 to provide content to the user equipment 210. For example, the termination system 250 may start the process of setting up scheduling of resources in response to (e.g., based on) the (S9.2) prescheduling message. If the termination system 250 starts receiving content before expiration of the timer time, the termination system 250 may communicate content through the target base station-DU 220 to the user equipment 210. If the termination system 250 does not start receiving content until after expiration of the timer time, the termination system 250 may revert to communicating content through the source base station-DU 130 to the UE 110 (e.g., indicative of the handover to the target base station-DU 120 failing). The prescheduling command between the base station-CU 260 and the termination system 250 may reduce latency as compared with solutions that wait to schedule resources until a handover or transfer of the user equipment 210 to the target base station-DU 220 is complete.

The sequence diagram 200 is an example, and does necessarily reflect relative timing between various messages. In addition, more or fewer messages than those depicted may be sent between the various components shown in the sequence diagram 200.

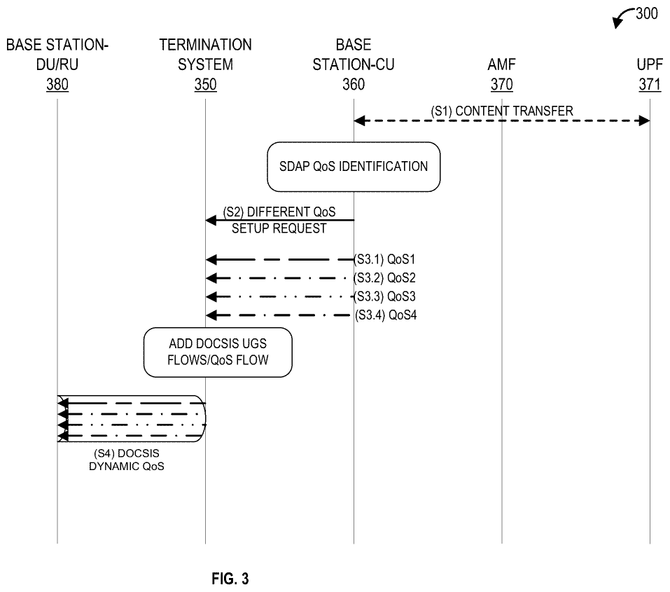

FIG. 3 is a sequence diagram 300 of an end-to-end QoS process for RAN in accordance with embodiments of the disclosure. The base station DU/RU 380, the termination system 350, the base station-CU 360, and/or the AMF 370/UPF 371, may correspond to the target base station DU/RU 120 and/or the source base station DU/RU 130, termination system 150, the base station-CU 160, and the AMF/UPF 170, respectively, of FIG. 1, for example.

As shown in FIG. 3, (S1) data and other messages may be transferred from the AMF 370/UPF 371 to the base station DU/RU 380 via the base station-CU 360 and the termination system 350. For example, the base station-CU 360 may implement SDAP Qos identification to determine QoS for various types of data and end user needs. For example, the base station-CU 360 and the termination system 350 may include an interface to set up QoS for various content types. For example, the base station-CU 360 and the termination system 350 may exchange (S2) a pair of QoS setup request/response messages. The setup may indicate a number of QoS tiers. The base station-CU 360 may sequentially send (S3.1)-(S3.4) QoS tier messages to set up the various QoS tiers. For example, the base station-CU 360 may sequentially send (S3.1)-(S3.4) QoS tier messages to set up the various QoS tiers after the exchange of the (S2) pair of QoS setup request/response messages. For example, the termination system 350 and the base station-CU 360 may use a CMTS 5G loopback interface to negotiate the QoS between the termination system 150 and the base station-CU 360 to establish an end-to-end QoS for the UE 110. When the termination system 350 receives a different QoS setup request, it may goes through a Kubernetes container that is part of a virtualized implementation of the virtualized termination system 350. The termination system 350 may align the required QoS from a 5G network to a DOCSIS network, to provide complete end-to-end QoS. The termination system 350 may sequentially send the QoS tiers to be set up using DOCSIS unsolicited grant service (UGS) flows, with one QoS flow per DOCSIS UGS flow through the base station DU/RU 380 to a user equipment (not shown) via (S4) a DOCSIS dynamic QoS message. The base station DU/RU 380 may use the QoS information for data transfer between the base station DU/RU 380 and user equipment (not shown).

The sequence diagram 300 is an example, and does necessarily reflect relative timing between various messages. In addition, more or fewer messages than those depicted may be sent between the various components shown in the sequence diagram 300.

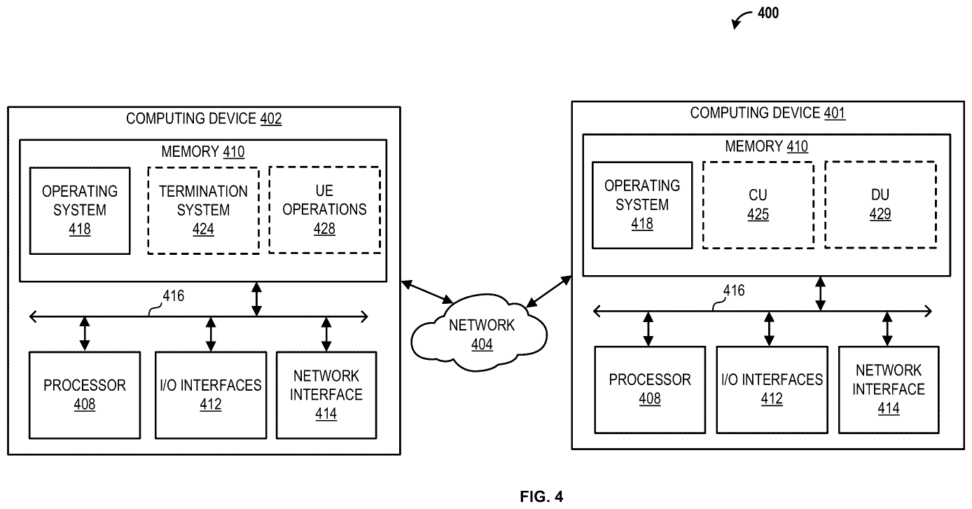

The present methods and systems may be computer-implemented. FIG. 4 is a block diagram depicting a system/environment 400 in accordance with embodiments of the disclosure. The system 400 may include non-limiting examples of a computing device (or server) 401 and a computing device (or server) 402 connected through a network 404. The computing device 401 may implement or host functionality of the UE 110 and/or the termination system 150 of FIG. 1, the user equipment 210 and/or the termination system 250 of FIG. 2, and/or the 310 and/or the termination system 350 of FIG. 3, for example. The computing device 402 may implement or host functionality of the target base station-DU 120, the source base station-DU 130, and/or the base station-CU 160 of FIG. 1, the target base station-DU 220, the source base station-DU 230, and/or the base station-CU 260 of FIG. 2, the 330 and/or the base station-CU 360 of FIG. 3, for example. In an aspect, some or all steps of any described method may be performed on a computing device as described herein. The computing device 401 may comprise one or multiple computers configured to store instructions for the termination system 424 or UE operation 428 to implement the functionality of the termination systems or UEs described herein. The computing device 402 may comprise one or multiple computers configured to store instructions for base station centralized units 425 or base station distributed units 429 to implement the functionality of the base station- CUs or base station-DUs, respectively, described herein. Multiple computing devices 401 and/or 402 may communicate through the network 404.

The computing device 401 and the computing device 402 may be a digital computer that, in terms of hardware architecture, generally includes a processor 408, system memory 410, input/output (I/O) interfaces 412, and network interfaces 414. These components (408, 410, 412, and 414) are communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the computing device 402, a semiconductor-based microprocessor (in the form of a microchip or chip set), or generally any device for executing software instructions. During operation of the computing device 401 and/or the computing device 402, the processor 408 may execute software stored within the system memory 410, to communicate data to and from the system memory 410, and to generally control operations of the computing device 401 and the computing device 402 pursuant to the software.

The I/O interfaces 412 may be used to receive user input from, and/or for sending system output to, one or more devices or components. User input may be received via, for example, a keyboard and/or a mouse. System output may be output via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the computing device 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise instructions for the termination system 424 or the user equipment operations 428, and a suitable operating system (O/S) 418. In the example of FIG. 4, the software in the system memory 410 of the computing device 402 may comprise instructions for the base station centralized units 425 or base station distributed units 429, and a suitable operating system (O/S) 418. The operating system 418 essentially controls the execution of other computer programs and may enable virtualization of the termination system 424, the base station centralized units 425, and/or base station distributed units 429. In some examples, the O/S is a hypervisor configured to host virtual machines or containers to support virtualization.

For purposes of illustration, application programs and other executable program components such as the operating system 418 are shown herein as discrete blocks, although it is recognized that such programs and components may reside at various times in different storage components of the computing device 401 and/or the computing device 402. An implementation of the system/environment 400 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Examples of computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

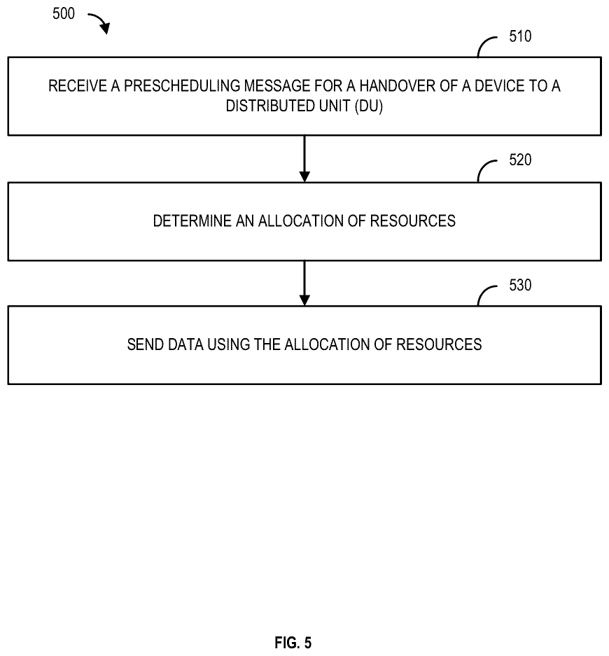

FIG. 5 depicts a flowchart of an example method 500 to perform a handover operation in accordance with embodiments of the disclosure. The method 500 may be performed in whole or in part by a single computing device, a plurality of computing devices, and the like. For example, the method 500 may be performed by the termination system 150 of FIG. 1, the termination system 250 of FIG. 2, the termination system 350 of FIG. 3, and/or the termination system 424 of FIG. 4.

The method 500 may include receiving, at a termination system from a base station centralized unit (CU), a prescheduling message indicating a handover of a device to a base station distributed unit (DU), at 510. For example, the termination system is a cable modem termination system. The base station CU may be implemented in the base station-CU 160 of FIG. 1, the base station-CU 260 of FIG. 2, the base station-CU 360 of FIG. 3, and/or the base station CU 425 of FIG. 4. The base station DU may be implemented in the target base station-DU 120 or the source base station-DU 130 of FIG. 1, the target base station-DU 220 or the source base station-DU 230 of FIG. 2, the 330 of FIG. 3, and/or the base station DU 429 of FIG. 4. The device may be implemented in the UE 110 of FIG. 1, the user equipment 210 of FIG. 2, the 310 of FIG. 3, and/or the UE operations 428 of FIG. 4.

The method 500 may further include, based on the prescheduling message, determining an allocation of resources to use to communicate to the device via the base station DU, at 520. The prescheduling message may include the 9.2 prescheduling message of the sequence diagram 200 of FIG. 2.

The method 500 may include based on receipt of the data intended for the device, sending the data using the allocation of resources to the base station DU, at 530. For example, the method 500 further includes sending the data based on a data over cable service interface specification (DOCSIS) standard. For example, the method 500 further includes sending the data based on a 3^{rd} Generation Partnership Project (3GPP) interfaces standard. For example, the method 500 further includes sending the data based on a data over any other suitable standard.

For example, the method 500 may include based on receipt of the data intended for the device before an amount of time from receipt of the prescheduling message exceeds a timer value received with the prescheduling message, sending the data using the allocation of resources to the base station DU. For example, based on receipt of the data intended for the device after an amount of time from receipt of the prescheduling message exceeds a timer value received with the prescheduling message, sending the data using an allocation of resources associated with another base station DU in communication with the device. The timer may correspond to the timer sent with the 7. RRC reconfiguration message of the sequence diagram of FIG. 2. For example, the method 500 may include receiving a timer value with the prescheduling message. For example, the timer value corresponds to a T304 timer value specified in a 3^{rd} Generation Partnership Project 5G-new radio or derivative standard.

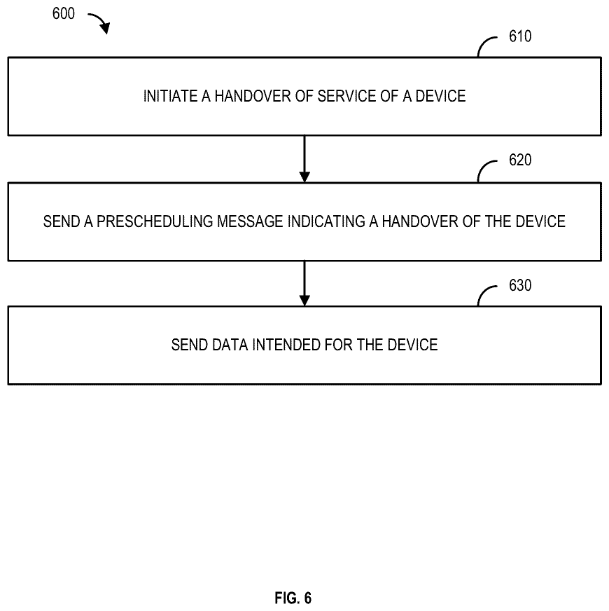

FIG. 6 depicts a flowchart of an example method 600 to perform a handover operation in accordance with embodiments of the disclosure. The method 600 may be performed in whole or in part by a single computing device, a plurality of computing devices, and the like. For example, the method 600 may be performed by the base station-CU 160 of FIG. 1, the base station-CU 260 of FIG. 2, the base station-CU 360 of FIG. 3, and/or the base station CU 425 of FIG. 4.

The method 600 may include initiating, at a base station centralized unit (CU), a handover of service of a device from a first base station distributed unit (DU) to a second base station DU, at 610. The termination system may be implemented in the termination system 150 of FIG. 1, the termination system 250 of FIG. 2, the termination system 350 of FIG. 3, and/or the 424 of FIG. 4. For example, the termination system is a cable modem termination system. The first and second base station DUs may be implemented in the source base station-DU 130 or the target base station-DU 120, respectively, of FIG. 1, the source base station-DU 230 or the target base station-DU 220, respectively, of FIG. 2, the 330 of FIG. 3, and/or the base station DU 429 of FIG. 4. The device may be implemented in the UE 110 of FIG. 1, the user equipment 210 of FIG. 2, the 310 of FIG. 3, and/or the UE operations 428 of FIG. 4.

For example, the method 600 may further include initiating, at the base station CU, the handover of service of a device from the first base station DU to the second base station DU based on a signal quality metric associated with communication between the device and the first base station satisfies a threshold. The signal quality metric may be received in a measurement report sent from the device (e.g., the 2. measurement report message in the sequence diagram of FIG. 2).

For example, the method 600 may further include sending a device context setup request message to the second base station DU to initiate the handover of service of the device from the first base station DU to the second base station DU. The user context setup request message may include the 4. UE context setup request message of the sequence diagram 200 of FIG. 2.

The method 600 may further include based on receipt of a modification response from the first base station DU, providing, to a termination system, a prescheduling message indicating a handover of the device to the second base station DU, at 620. The prescheduling message may include the 9.2 prescheduling message of the sequence diagram 200 of FIG. 2. For example, the method 600 may further include sending a timer value with the prescheduling message. The timer value may be associated with a timer value used to determine an amount of time that the device has to complete the handover. For example, the timer may correspond to the timer sent with the 7. RRC reconfiguration message of the sequence diagram of FIG. 2. For example, the timer value corresponds to a T304 timer value specified in a 3^{rd} Generation Partnership Project 5G-new radio or derivative standard.

The modification response may include the 8. modification response message of the sequence diagram of FIG. 2. For example, the method 600 may further include based on receipt of a modification response from the first base station DU, buffering the data intended for the device. For example, the method 600 may further include prior to receipt of the modification response, sending, to the first base station DU, a modification request message to cause the first base station DU to inform the device of the handover. The modification request may include the 7. modification request message of the sequence diagram 200 of FIG. 2.

The method 600 may include based on receipt of a transfer message from the second base station DU, sending, to the termination system, data intended for the device, at 630. The transfer message may include the 10. UL RRC message transfer of the sequence diagram 200 of FIG. 2. For example, the method 600 further includes sending the data based on a data over cable service interface specification (DOCSIS) standard. For example, the method 600 further includes sending the data based on a 3^{rd} Generation Partnership Project (3GPP) interfaces standard. For example, the method 600 further includes sending the data based on a data over any other suitable standard.

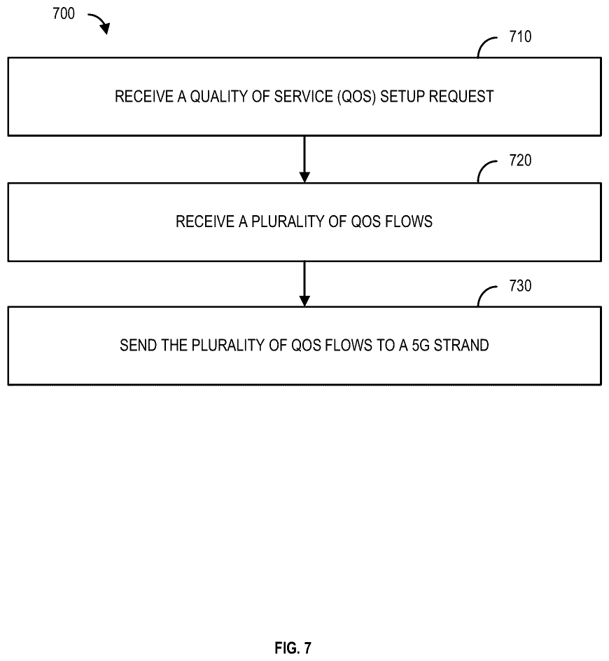

FIG. 7 depicts a flowchart of an example method 700 to perform a QoS update operation in accordance with embodiments of the disclosure. The method 700 may be performed in whole or in part by a single computing device, a plurality of computing devices, and the like. For example, the method 700 may be performed by the termination system 150 of FIG. 1, the termination system 250 of FIG. 2, the termination system 350 of FIG. 3, and/or the termination system 424 of FIG. 4.

The method 700 may include receiving, at a termination system from a base station centralized unit (CU), a quality of service (QoS) setup request, at 710. For example, the termination system is a cable modem termination system. The base station CU may be implemented in the base station-CU 160 of FIG. 1, the base station-CU 260 of FIG. 2, the base station-CU 360 of FIG. 3, and/or the base station CU 425 of FIG. 4. The QoS setup request may include the 2. different QoS setup request of the sequence diagram 300 of FIG. 3.

The method 700 may further include receiving, from the base station CU, a plurality of QoS flows, at 720. The prescheduling message may include the 9.2 prescheduling message of the sequence diagram 200 of FIG. 2. The plurality of QoS flows may include the 3.1-3.4. QoS flows of the sequence diagram 300 of FIG. 3. For example, the method 700 may further include sending the plurality of QoS flows to a 5G cell using a plurality of unsolicited grant service (UGS) flows. For example, each of the plurality of QoS flows may correspond to one of the plurality of UGS flows. For example, the plurality of UGS flows is associated with data over cable service interface specification (DOCSIS) standard. For example, the method 700 may further include communicating with the base station CU using a 5G loopback interface of a 3^{rd} Generation Partnership Project (3GPP) interfaces standard to determine the plurality of QoS flows.

The method 700 may include sending the plurality of QoS flows to a 5G base station DU/RU, at 730. The base station DU/RU may be implemented in the base station DU/RU 380 of FIG. 3. For example, the method 700 further includes sending data according to a 3^{rd} Generation Partnership Project (3GPP) interfaces standard based on the plurality of QoS flows.

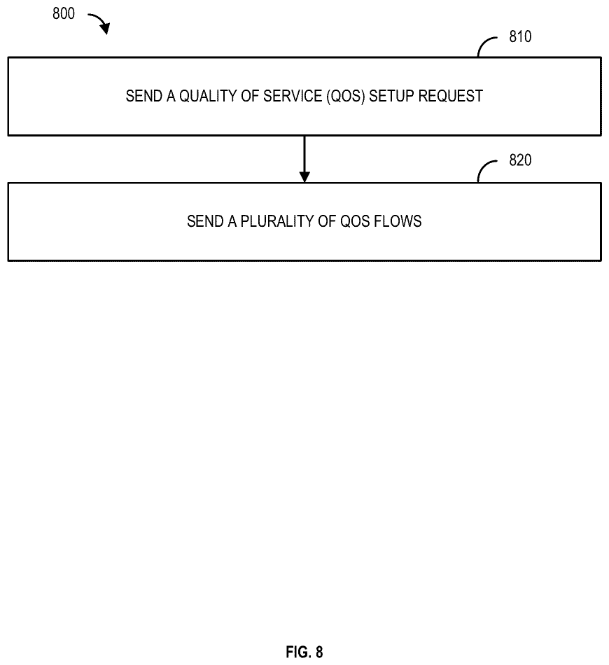

FIG. 8 depicts a flowchart of an example method 800 to perform a handover operation in accordance with embodiments of the disclosure. The method 800 may be performed in whole or in part by a single computing device, a plurality of computing devices, and the like. For example, the method 800 may be performed by the base station-CU 160 of FIG. 1, the base station-CU 260 of FIG. 2, the base station-CU 360 of FIG. 3, and/or the base station CU 425 of FIG. 4.

The method 800 may include sending, from a base station centralized unit (CU) to a termination system, a quality of service (QoS) setup request, at 810. The termination system may be implemented in the termination system 150 of FIG. 1, the termination system 250 of FIG. 2, the termination system 350 of FIG. 3, and/or the termination system 424 of FIG. 4. For example, the termination system is a cable modem termination system. For example, the method 800 may further include receiving, at the base station CU, QoS designations corresponding to the plurality of QoS flows. For example, the QoS designations are received from a user plane function (e.g., the AMF/UPF 170 of FIG. 1, the UPF 271 of FIG. 2, the UPF 371 of FIG. 3, etc.). For example, the method 800 may include identifying the plurality of QoS flows using a service data application protocol. For example, the method 800 may include communicating with the termination system using a 5G loopback interface of a 3^{rd} Generation Partnership Project (3GPP) interfaces standard to determine the plurality of QoS flows.

The method 800 may further include sending, from the base station CU, a plurality of QoS flows, wherein the plurality of QoS flows are sent by the termination system to a 5G base station DU/RU, at 820.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as examples only, with a true scope and spirit being indicated by the following claims.

1. A method comprising:
receiving, at a termination system from a base station centralized unit (CU), a prescheduling message indicating a handover of a device to a base station distributed unit (DU);
based on the prescheduling message, determining an allocation of resources to use to communicate to the device via the base station DU; and
based on receipt of data intended for the device, sending the data using the allocation of resources to the base station DU.

2. The method of claim 1, further comprising, based on receipt of the data intended for the device before an amount of time from receipt of the prescheduling message exceeds a timer value received with the prescheduling message, sending the data using the allocation of resources to the base station DU.

3. The method of claim 2, further comprising receiving the timer value with the prescheduling message.

4. The method of claim 2, wherein the timer value corresponds to a T304 timer value specified in a 3^{rd} Generation Partnership Project 5G-new radio or derivative standard.

5. The method of claim 1, further comprising, based on receipt of the data intended for the device after an amount of time from receipt of the prescheduling message exceeds a timer value received with the prescheduling message, sending the data using an allocation of resources associated with another base station DU in communication with the device.

6. The method of claim 1, further comprising sending the data based on a data over cable service interface specification (DOCSIS) standard.

7. The method of claim 1, further comprising sending the data based on a 3^{rd} Generation Partnership Project (3GPP) interfaces standard.

8. The method of claim 1, wherein the termination system is a cable modem termination system.

9. A method comprising:
initiating, at a base station centralized unit (CU), a handover of service of a device from a first base station distributed unit (DU) to a second base station DU;
based on receipt of a modification response from the first base station DU, sending, to a termination system, a prescheduling message indicating a handover of the device to the second base station DU; and
based on receipt of a transfer message from the second base station DU, sending, to the termination system, data intended for the device.

10. The method of claim 9, further comprising, based on receipt of a modification response from the first base station DU, buffering the data intended for the device.

11. The method of claim 9, further comprising initiating, at the base station CU, the handover of service of a device from the first base station DU to the second base station DU based on a signal quality metric associated with communication between the device and the first base station satisfies a threshold.

12. The method of claim 9, further comprising sending a device context setup request message to the second base station DU to initiate the handover of service of the device from the first base station DU to the second base station DU.

13. The method of claim 9, further comprising prior to receipt of the modification response, sending, to the first base station DU, a modification request to cause the first base station DU to inform the device of the handover.

14. The method of claim 9, further comprising sending a timer value with the prescheduling message, wherein the timer value is associated with a timer value used to determine an amount of time that the device has to complete the handover.

15. The method of claim 9, wherein the data is sent based on a data over cable service interface specification (DOCSIS) standard.

16. The method of claim 9, wherein the data is sent based on a 3^{rd} Generation Partnership Project (3GPP) interfaces standard.

17. The method of claim 9, wherein the termination system is a cable modem termination system.

18. A method comprising:
receiving, at a termination system from a base station centralized unit (CU), a quality of service (QoS) setup request;
receiving, from the base station CU, a plurality of QoS flows; and
sending the plurality of QoS flows to a 5G base station distributed unit(DU)/radio unit (RU).

19. The method of claim 18, further comprising sending the plurality of QoS flows to the 5G base station DU/RU using a plurality of unsolicited grant service (UGS) flows.

20. The method of claim 19, wherein each of the plurality of QoS flows corresponds to one of the plurality of UGS flows.

21. The method of claim 19, wherein the plurality of UGS flows is associated with data over cable service interface specification (DOCSIS) standard.

22. The method of claim 18, further comprising communicating with the base station CU using a 5G loopback interface of a 3^{rd} Generation Partnership Project (3GPP) interfaces standard to determine the plurality of QoS flows.

23. The method of claim 18, further comprising sending data according to a 3^{rd} Generation Partnership Project (3GPP) interfaces standard based on the plurality of QoS flows.

24. The method of claim 18, wherein the termination system is a cable modem termination system.

25. A method comprising:
sending, from a base station centralized unit (CU) to a termination system, a quality of service (QoS) setup request; and
sending, from the base station CU, a plurality of QoS flows, wherein the plurality of QoS flows are sent by the termination system to a 5G base station distributed unit(DU)/radio unit (RU).

26. The method of claim 25, receiving, at the base station CU, QoS designations corresponding to the plurality of QoS flows.

27. The method of claim 26, wherein the QoS designations are received from a user plane function.

28. The method of claim 25, further comprising communicating with the termination system using a 5G loopback interface of a 3^{rd} Generation Partnership Project (3GPP) interfaces standard to determine the plurality of QoS flows.

29. The method of claim 25, further comprising identifying the plurality of QoS flows using a service data application protocol.

30. The method of claim 25, wherein the termination system is a cable modem termination system.
